(19) United States
(12) Patent Application Publication
(10) Pub. No.: US 2025/0018875 A1
(43) Pub. Date: Jan. 16, 2025

(54) ROOF MODULE FOR FORMING A VEHICLE ROOF AND MOTOR VEHICLE WITH A ROOF MODULE

(71) Applicant: Webasto SE, Stockdorf (DE)

(72) Inventor: Magnus SVIBERG, Stockdorf (DE)

(21) Appl. No.: 18/756,324

(22) Filed: Jun. 27, 2024

(30) Foreign Application Priority Data
Jul. 11, 2023 (DE) 10 2023 118 277.3

(51) Int. Cl. B60R 11/00; B62D 25/06

(52) U.S. Cl. CPC B60R 11/00; B62D 25/06

(57) ABSTRACT

A roof module for forming a vehicle roof on a motor vehicle includes at least one environment sensor configured to detect a vehicle environment, at least one panoramic roof element, sunroof and/or sliding roof, and a kinematic mechanism configured to move the at least one environment sensor from at least one retracted position, in which the at least one environment sensor is at least partially located below the roof skin and at least partially projects into the at least one panoramic roof element, sunroof and/or sliding roof, into at least one deployed position, in which the environment sensor projects above the roof skin and at least partially projects over an outer edge area of the roof module.

### CROSS-REFERENCE TO RELATED APPLICATION(S)

This application claims the benefit of German Patent Application No. 10 2023 118 277.3 filed Jul. 11, 2023, which is incorporated herein by reference in its entirety.

### TECHNICAL FIELD

The invention relates to a roof module for forming a vehicle roof on a motor vehicle according to the preamble of claim 1. Furthermore, the invention relates to a motor vehicle having at least one roof module of this kind.

### BACKGROUND

Generic roof modules are used extensively in vehicle construction, as these roof modules can be prefabricated as separate functional modules and delivered to the assembly line when the vehicle is assembled. The outer surface of the roof module at least partially forms a roof skin of the vehicle roof, which prevents moisture or airflows from entering the vehicle interior. The roof skin is formed, for example, by one or more panel components, which can be made of a stable material, such as painted sheet metal or painted or dyed-through plastic. The roof module can be part of a rigid vehicle roof or part of an openable roof assembly.

Furthermore, developments in vehicle construction are increasingly focusing on autonomous or semi-autonomous motor vehicles. In order to enable the vehicle control system to control the motor vehicle autonomously or semi-autonomously, a plurality of environment sensors (e.g., lidar sensors, radar sensors, (multi-) cameras, etc. including other (electrical) components) are used, which are integrated into the roof module, for example, detect the environment surrounding the motor vehicle and determine, for example, a current traffic situation from the detected environment data. Roof modules which are equipped with a plurality of environment sensors are also known as roof sensor modules (RSM). The known environment sensors send and/or receive electromagnetic signals, such as laser beams or radar beams, allowing a data model of the vehicle environment to be generated by a signal evaluation and to be used for controlling the vehicle.

The environment sensors for monitoring and detecting the vehicle environment are usually attached to the vehicle roof, as the vehicle roof is usually the highest point of a vehicle, from which the vehicle environment is clearly visible. Various kinematic mechanisms are known from the state of the art for adjusting such an environment sensor between a retracted position, in which the environment sensor is usually disposed in an installation space below the roof skin, and a deployed position, in which the environment sensor projects above the roof skin in order to detect the vehicle environment. Adjustable environment sensors of this kind are also known in combination with roof modules that have a panoramic roof and/or a sliding roof and/or a sunroof.

In the known designs, the environment sensor is usually disposed in an installation space area between a front windshield and a panoramic roof and/or a sliding roof and/or a sunroof. The placement and/or integration of the adjustable environment sensors between the windshield and the panoramic roof and/or the sliding roof and/or the sunroof has the consequence that the transparent area of the panoramic roof and/or the sliding roof and/or the sunroof or an opening area of the sliding roof has to be limited in size in order to provide the installation space required for the environment sensor, in particular in the longitudinal vehicle direction. As a result, a front edge of the panoramic roof and/or the sliding roof and/or the sunroof in particular moves further back in the direction of a roof center. As a result, the available see-through area and/or opening area is reduced, which leads to a disadvantageous ambiance in the vehicle interior.

### SUMMARY

Hence, the object of the invention is to propose a roof module, in particular a roof module with an improved kinematic mechanism.

This object is attained by a roof module according to the teaching of claim 1. Furthermore, this object is attained by a motor vehicle according to the teaching of claim 12.

Advantageous embodiments of the invention are the subject of the dependent claims. All combinations of at least two features disclosed in the description, the claims and/or the figures fall within the scope of the invention. It is understood that the explanations given with respect to the roof module equivalently relate to the present motor vehicle and to the method without being mentioned redundantly for the latter. In particular, it is to be understood that the present disclosure includes customary linguistic transformations and/or a meaningful replacement of respective terms within the framework of customary linguistic practice, in particular the use of synonyms supported by the generally recognized linguistic literature, without being explicitly mentioned in their respective formulations.

In its intended use, the present roof module is designed for forming a vehicle roof on a motor vehicle. The roof module has at least one environment sensor configured to detect a vehicle environment, in particular at least partly and/or partially around the motor vehicle. The roof module further comprises at least one panoramic roof element and/or one sunroof and/or one sliding roof and a kinematic mechanism configured to adjust the at least one environment sensor from at least one retracted position, in which the at least one environment sensor is at least partially located below the roof skin, into at least one deployed position, in which the environment sensor projects above the roof skin, in particular in order to detect the vehicle environment. The kinematic mechanism is configured to move the at least one environment sensor into the at least one retracted position in such a manner that the at least one environment sensor, in particular viewed in a longitudinal vehicle direction, at least partially projects into the at least one panoramic roof element and/or the at least one sunroof and/or the at least one sliding roof, in particular in the direction of a roof center and/or a vehicle center. Alternatively or additionally, the kinematic mechanism is configured to move the at least one environment sensor, in particular starting from the at least one retracted position, into the at least one deployed position in such a manner that the at least one environment sensor, viewed in the longitudinal vehicle direction, at least partially projects and/or protrudes and/or juts out over an outer edge area of the roof module.

In the case at hand, the at least one environment sensor is preferably disposed in front of the roof area formed by the at least one panoramic roof element and/or the at least one sunroof and/or the at least one sliding roof. The at least one environment sensor is adjustable and/or movable, i.e., in other words, retractable and deployable, relative to the roof skin. In the at least one retracted, in particular inactive, position, the at least one environment sensor preferably projects toward the rear above a front edge of the panoramic roof element and/or the sliding roof and/or the sunroof or projects over a front edge of the panoramic roof element and/or the sliding roof and/or the sunroof, in particular when it is disposed at the front of the vehicle roof. In the at least one deployed, in particular active, position, on the other hand, this projection no longer exists, as the environment sensor has been moved away accordingly by the kinematic mechanism. This means that the size of the panoramic roof element and/or the sliding roof and/or the sunroof does not have to be limited. The transparent and/or openable roof area can thus be larger and, in particular, extend further towards a front windshield edge of the vehicle. The enlargement of the panoramic roof element and/or the sliding roof and/or the sunroof creates an improved ambiance within the vehicle, i.e., in the vehicle interior. Alternatively or additionally, the at least one environment sensor can project forwards over the upper edge or roof-side outer edge of the windshield when in the at least one deployed position, in particular when it is disposed at the front, as a result of which the panoramic roof element and/or the sliding roof and/or the sunroof can be even larger and extend or be designed further forward. As a result, a roof surface with a significantly larger see-through area and/or opening area compared to the prior art can be realized. The placement options shown here for enlarging the available see-through area and/or opening area can be implemented individually or in combination with each other.

The present roof module has the advantages that the at least one environment sensor and/or a sensor field of view can be better utilized. Furthermore, a panoramic roof element and/or a sliding roof and/or a sunroof or the transparent roof area and/or the openable area on the vehicle roof can be of a larger design. Overall, the present placement of the environment sensor can achieve improved styling of the motor vehicle with better integration of the system design. The packaging, i.e., the installation space utilization, and/or the design and/or the visual appearance of the motor vehicle is/are also improved. Moreover, the roof module can be manufactured with lower production costs.

In a preferred embodiment, the kinematic mechanism is configured to move the at least one environment sensor between the at least one retracted position and the at least one deployed position in a, in particular combined, rotational movement, in particular about at least one axis of movement, and/or in a translational movement, in particular along at least one axis of movement. The at least one environment sensor can, for example, perform a translational movement in order to be moved from the state of projection over the edge area of the panoramic roof and/or the sliding roof and/or the sunroof to a position in which it can be deployed from an installation space in an interior of the roof module by a rotational movement. The translational movement can merge into the rotational movement and vice versa, or both movements can occur simultaneously. The exact movement sequence depends on the environment sensor and the exact way it is attached to the roof module. In addition, the exact movement sequence depends on the kinematic mechanism, so the movement sequence should not be restricted to specific movement sequences in the case at hand.

In a preferred embodiment, the at least one environment sensor has a sensor housing, the kinematic mechanism having at least two guide levers, which are each connected to the at least one sensor housing in a rotating manner at one end and which are each connected to a support structure of the roof module in a rotating manner at the other end. The support structure can, for example, be a roof module frame on which the panoramic roof and/or the sunroof and/or the sliding roof is disposed. At least one panel component can also be disposed on the roof module frame. The roof module frame can be used to place the roof module on a vehicle body as a pre-assembled unit. In principle, the support structure can also be another structural component and/or stiffener and/or strut on the roof module. In principle, the support structure can also be part of a vehicle body. The two ends of the respective guide levers are preferably located opposite each other. The guide levers can be of the same length or of different lengths. The guide levers are preferably hinged to or rotatable on the sensor housing.

In a preferred embodiment, at least a first one of the at least two guide levers has a sliding pin which is held in a first guide track in a sliding manner. The sliding pin is preferably captively and/or permanently disposed on the guide levers. The sliding pin is preferably disposed between the two ends of the first guide lever, in particular in a central area of the first guide lever.

In a preferred embodiment, the kinematic mechanism has at least one other adjustment lever, which is connected to the second one of the at least two guide levers in a rotating manner at one end and which has a sliding pin at the other end, the sliding pin being held in a second guide track in a sliding manner. The adjustment lever is preferably disposed between the two ends of the second guide lever, in particular in a central area of the second guide lever. The adjustment lever is preferably connected to the second guide levers in a rotating manner. This can be done through a connection with a bolt or a screw, for example.

In a preferred embodiment, the at least one environment sensor has a lid element which is coupled to at least one part of the kinematic mechanism and/or to the sensor housing in a movement-transferring manner via at least one coupling element. The at least one coupling element can basically be of any design. The at least one coupling element is preferably used to move the lid element between the retracted position and the deployed position together with the sensor housing. The at least one coupling element can be designed in such a way that the lid element performs a movement and/or a movement sequence that differs from a movement sequence of the sensor housing during adjustment between the retracted position and the deployed position. In the retracted position, the lid element is preferably flush with the surrounding roof skin of the roof module. The lid element preferably conceals an opening in which the at least one environment sensor is disposed. Multiple lid elements can also be provided. The lid element can also have at least one seal, which can prevent water and/or moisture from entering the opening, at least in the closed position.

In a preferred embodiment, the at least one environment sensor has a cover, which is disposed on the inside of the roof module in particular and which is coupled to at least one part of the kinematic mechanism and/or to the sensor housing and/or the lid element in a movement-transferring manner via at least one other coupling element. The cover can be formed, for example, by a textile or another movable and/or flexible material and serves in particular to cover and/or at least partially enclose the environment sensor and/or the sensor housing towards the inside. The cover can improve the visual appearance of the at least one environment sensor from the perspective of an occupant, in particular in the retracted position. Furthermore, the cover preferably provides a sealing barrier that prevents water from entering the interior of the roof module.

In a preferred embodiment, the at least one coupling element and/or the at least one other coupling element has at least one linkage and/or at least one Bowden cable and/or at least one pull cable and/or at least one push cable and/or a pull/push cable. In principle, other coupling elements not mentioned here are also conceivable.

In a preferred embodiment, the kinematic mechanism has at least one drive, the drive comprising an electric and/or an electromagnetic and/or an electromechanical and/or a pneumatic and/or a hydraulic drive. In principle, other drives not mentioned here are also conceivable.

In a preferred embodiment, the roof module has a panel component which at least partially forms a roof skin of the vehicle roof, the roof skin functioning in particular as an outer sealing surface of the roof module, the at least one environment sensor being disposed in an opening of the panel component, and the panel component preferably directly bordering the at least one panoramic roof element and/or one sunroof and/or one sliding roof.

In a preferred embodiment, the at least one environment sensor comprises a lidar sensor and/or a camera sensor and/or a multi-camera sensor and/or an ultrasonic sensor. Other sensor types are also conceivable.

A motor vehicle is also claimed herein, the motor vehicle comprising a vehicle body and at least one roof module of the present type, the roof module being disposed on the vehicle body as a pre-assembled unit. The motor vehicle may be a passenger car and/or a commercial vehicle and/or a transportation vehicle and/or a truck or the like.

Preferably, the motor vehicle has at least one windshield and/or one rear window and/or one side window, the kinematic mechanism being configured to move the at least one environment sensor, in particular starting from the at least one retracted position, into the at least one deployed position in such a manner that the at least one environment sensor, in particular viewed in the longitudinal vehicle direction or in the vehicle width direction (with the environment sensor preferably being disposed laterally), at least partially projects over the outer edge area of the roof module in the direction of the windshield or the rear window or the side window.

It is understood that the embodiments and embodiment examples mentioned above and to be explained below can be realized not only individually but also in any combination with each other without departing from the scope of the present invention. Moreover, all embodiments and embodiment examples of the roof module entirely relate to a motor vehicle comprising such a roof module.

### BRIEF DESCRIPTION OF DRAWINGS

An embodiment of the invention is schematically illustrated in the drawing and is explained below by way of example.

FIG. 1 is a schematic view of a roof module according to a present embodiment with an environment sensor in a retracted position;

FIG. 2 is a schematic view of a roof module according to a present embodiment with an environment sensor in a deployed position;

FIG. 3 is a side view of part of a roof module according to a present embodiment with an environment sensor in a retracted position;

FIG. 4 is a side view of part of a roof module according to a present embodiment with an environment sensor in a deployed position;

FIG. 5 is a bottom view of part of a roof module according to a present embodiment with an environment sensor in a retracted position;

FIG. 6 is a bottom view of part of a roof module according to a present embodiment with an environment sensor in a deployed position;

FIG. 7 is a side view of part of a roof module according to a present embodiment with an environment sensor in a retracted position and an exemplary kinematic mechanism;

FIG. 8 is a side view of part of a roof module according to a present embodiment with an environment sensor in a deployed position and an exemplary kinematic mechanism;

FIG. 9 is a sectional view of part of a roof module according to a present embodiment with an environment sensor in a retracted position with a sliding roof closed;

FIG. 10 is a sectional view of part of a roof module according to a present embodiment with an environment sensor in a deployed position with a sliding roof closed;

FIG. 11 is a sectional view of part of a roof module according to a present embodiment with an environment sensor in a deployed position with a sliding roof open; and

FIG. 12 is a sectional view of part of a roof module according to a present embodiment with an environment sensor in a fully deployed position with a sliding roof open.

### DETAILED DESCRIPTION

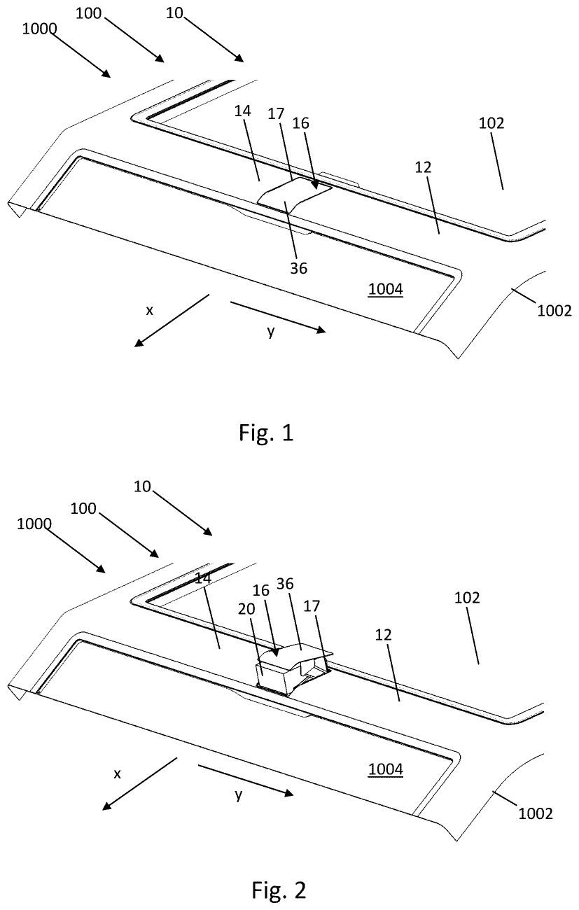

FIG. 1 shows a motor vehicle 1000 with a vehicle body 1002 and at least one roof module 10, which at least partially forms a vehicle roof 100 of the motor vehicle 1000. The roof module 10 is disposed on the vehicle body 1002 as a pre-assembled unit. The motor vehicle 1000 has at least one windshield 1004. The motor vehicle 1000 can of course also have a rear window and/or at least one side window, which is/are not shown here.

In the case at hand, the roof module 10 comprises, by way of example, a panel component 12 which at least partially forms a roof skin 14 of the vehicle roof 100. Furthermore, the roof module 10 comprises at least one environment sensor 16 configured to detect a vehicle environment. The at least one environment sensor 16 is disposed in an opening 17 of the panel component 12. The at least one environment sensor 16 comprises a lidar sensor and/or a camera sensor and/or a multi-camera sensor and/or an ultrasonic sensor.

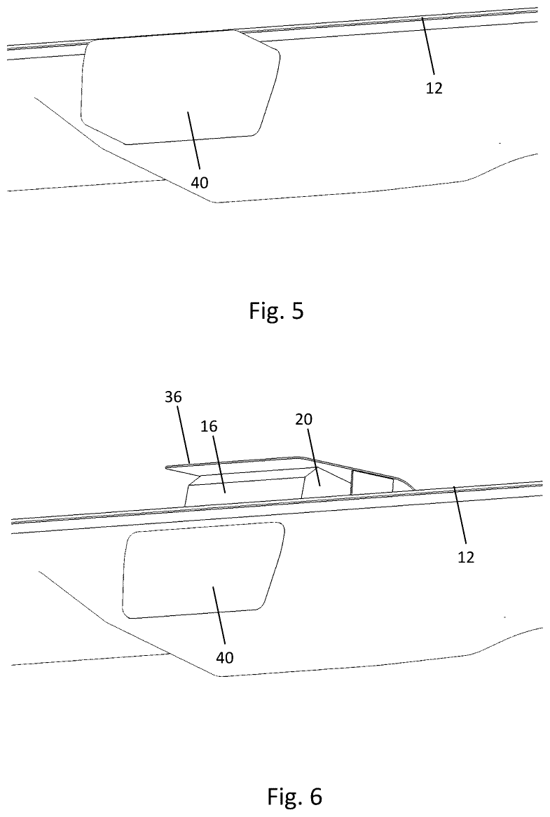

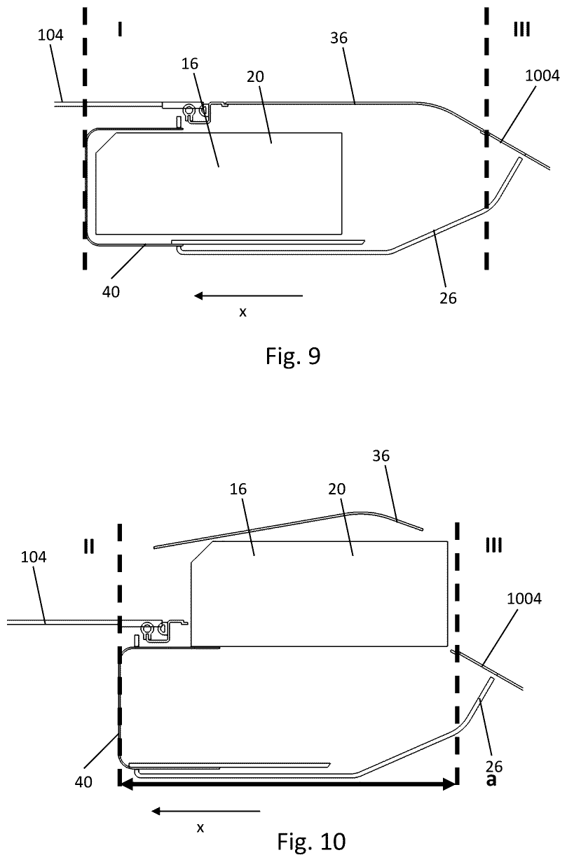

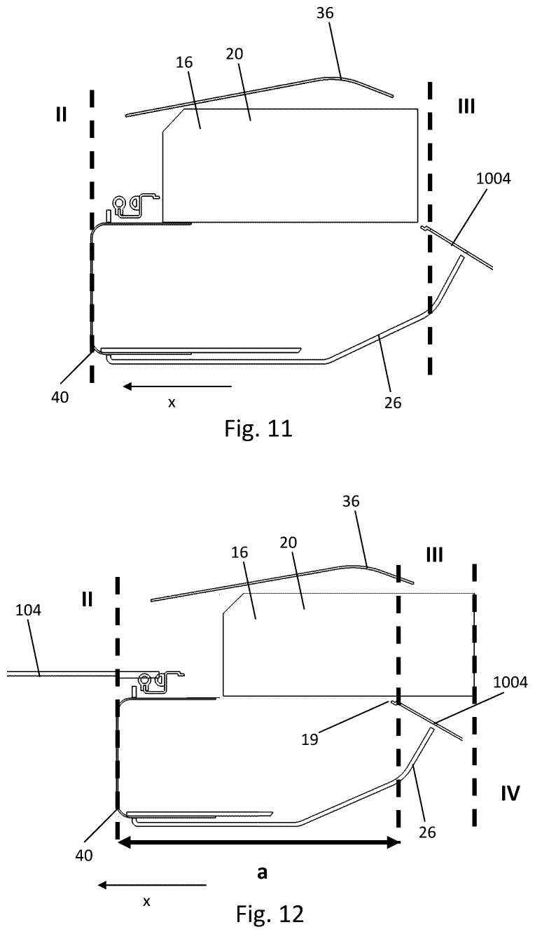

The roof module 10 comprises at least one panoramic roof element 102 and/or one sunroof and/or one sliding roof 104 (see FIGS. 9 to 12) and a kinematic mechanism 18. The kinematic mechanism 18 is configured to move the at least one environment sensor 16 from at least one retracted position (see FIGS. 1, 3, 5, 7 and 9), in which the at least one environment sensor 16 is at least partially located below the roof skin 14, into at least one deployed position (see FIGS. 2, 4, 6, 8, 10 to 12), in which the environment sensor 16 projects above the roof skin 14. In the present case, the panel component 12 borders the at least one panoramic roof element 102 and/or one sunroof and/or one sliding roof 104, as shown in particular in FIGS. 1 and 2.

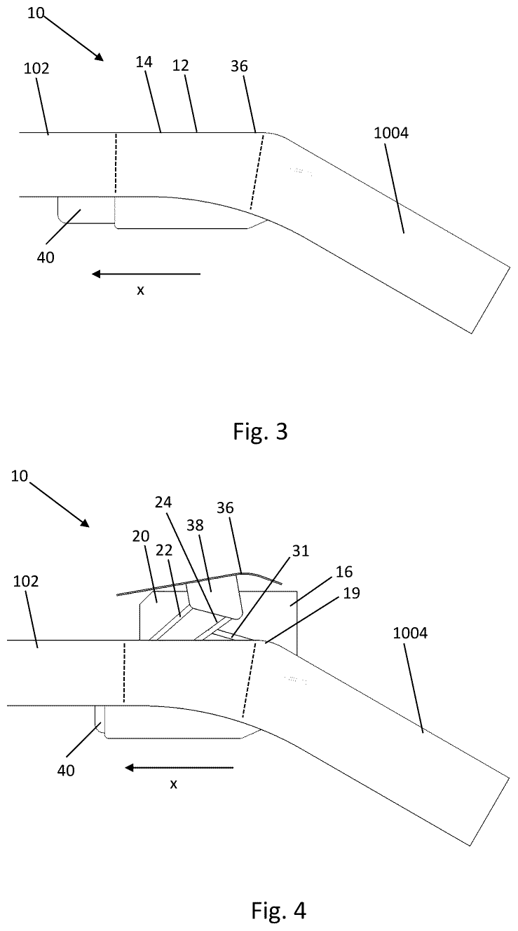

In the present case, the kinematic mechanism 18 is configured to move the at least one environment sensor 16 into the at least one retracted position in such a manner that the at least one environment sensor 16 at least partially projects into the at least one panoramic roof element 102 and/or the at least one sunroof and/or the at least one sliding roof 104 (see FIGS. 3 and 9). In the present case, the environment sensor 16 projects into the panoramic roof element 102 and/or the sliding roof 104 in a longitudinal vehicle direction x. The longitudinal vehicle direction x is orthogonal to a vehicle width direction y.

Alternatively or additionally, the kinematic mechanism 18 is configured to move the at least one environment sensor 16 into the at least one deployed position in such a manner that the at least one environment sensor 16, at least partially projects and/or protrudes over an outer edge area 19 of the roof module 10 (see FIGS. 4 and 12). Here, too, the longitudinal vehicle direction x is preferred as a reference variable.

The kinematic mechanism 18 is configured to move the at least one environment sensor 16 between the at least one retracted position and the at least one deployed position in a rotational movement and/or translational movement.

The at least one environment sensor 16 has a sensor housing 20, for example. For adjustment, the kinematic mechanism 18 has at least two guide levers 22, 24, for example, which are each connected to the at least one sensor housing 20 in a rotating manner at one end and which are each connected to a support structure 26 of the roof module 10 in a rotating manner at the other end.

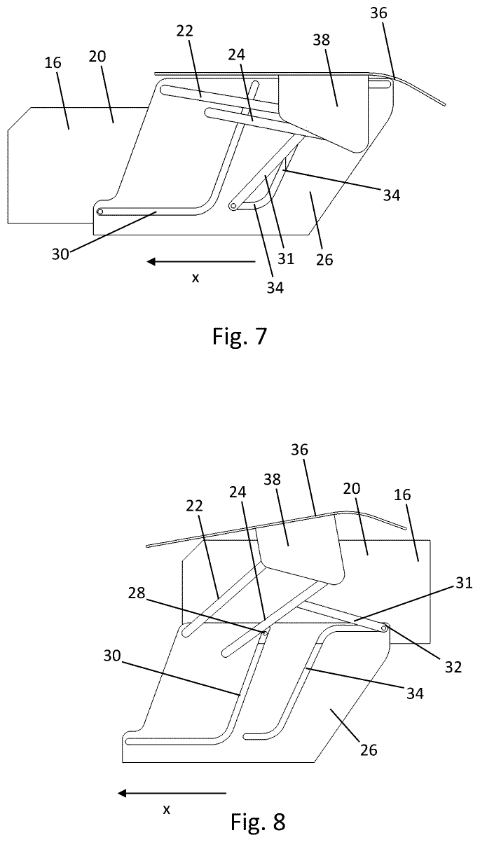

In the case at hand, at least a first one of the at least two guide levers 24 has a sliding pin 28, which is held in a first guide track 30 in a sliding manner (see FIGS. 7 and 8). The kinematic mechanism 18 has at least one other adjustment lever 31, which is connected to the second one of the at least two guide levers 24 in a rotating manner at one end and which has a sliding pin 32 at the other end, which is held in a second guide track 34 in a sliding manner. In the case at hand, the kinematic mechanism 18 has two sliding pins 28, 32, which are moved along two guide tracks 30, 34 or guide curves in the support structure 26 or the holder, for example with the aid of an electric motor that controls and/or determines the movement of the environment sensor. Other solutions for a kinematic mechanism 18 for forming a rotational movement and/or a translational movement of the environment sensor 16 are also possible.

The at least one environment sensor 16 comprises a lid element 36, which is coupled to at least one part of the kinematic mechanism 18 and/or to the sensor housing 20 in a movement-transferring manner via at least one coupling element 38.

The at least one environment sensor 16 further comprises a cover 40 and/or housing on the inside of the roof module which is coupled to at least one part of the kinematic mechanism 18 and/or to the sensor housing 20 and/or the lid element 36 in a movement-transferring manner via at least one other coupling element. So a mechanism, in particular with a four-bar linkage and a coupling element for the movement of the cover 40, is preferably connected to the environment sensor 16. The movement of the cover 40 in the inner lining can also be coupled to the movement of the environment sensor 16 and/or the lid element 36 via linkages, Bowden cables and/or pull and push cables, etc.

The at least one coupling element 38 and/or the at least one other coupling element may comprise at least one linkage and/or at least one Bowden cable and/or at least one pull cable and/or at least one push cable. Furthermore, the kinematic mechanism 18 can have at least one drive (not shown), and the drive may comprise an electric and/or an electromagnetic and/or an electromechanical and/or a pneumatic and/or a hydraulic drive.

As can be seen from FIGS. 9 to 12, the size of the panoramic roof element 102 and/or the sliding roof 104 can be increased and the front edge of the panoramic roof element 102 and/or the sliding roof 104 can be moved further forward in the direction of the wind shield 1004 owing to the present solution or method of mounting the environment sensor 16. The distance between I and II in FIG. 9 describes this improvement. The small area of the panoramic roof element 102 and/or the sliding roof 104 that is shaded by the environment sensor 16 (and the lid element 36) when the environment sensor 16 is retracted is limited to the area of the environment sensor 16 and does not impact the entire area of the panoramic roof element 102 and/or the sliding roof 104, as shown in FIGS. 9 to 12.

As can be seen in FIG. 12, the present solution allows the size of the panoramic roof element 102 and/or the sliding roof 104 to be increased and the front edge to be moved further forward. The distance a between Ill and IV in FIG. 12 describes this improvement.

### REFERENCE SIGNS

10 roof module
12 panel component
14 roof skin
16 environment sensor
17 opening
18 kinematic mechanism
19 edge area
20 sensor housing
22 guide lever
24 guide lever
26 support structure
28 sliding pin
30 guide track
31 adjustment lever
32 sliding pin
34 guide track
36 lid element
38 coupling element
40 cover
100 vehicle roof
102 panoramic roof element
104 sliding roof
1000 motor vehicle
1002 vehicle body
1004 windshield
a distance
x longitudinal vehicle direction
y vehicle width direction

1. A roof module for forming a vehicle roof on a motor vehicle, the roof module comprising at least one environment sensor configured to detect a vehicle environment, at least one panoramic roof element and/or one sunroof and/or one sliding roof, and a kinematic mechanism configured to move the at least one environment sensor from at least one retracted position, in which the at least one environment sensor is at least partially located below the roof skin, into at least one deployed position, in which the environment sensor projects above the roof skin, wherein the kinematic mechanism is configured to move the at least one environment sensor into the at least one retracted position in such a manner that the at least one environment sensor at least partially projects into the at least one panoramic roof element and/or the at least one sunroof and/or the at least one sliding roof and/or to move the at least one environment sensor into the at least one deployed position in such a manner that the at least one environment sensor at least partially projects over an outer edge area of the roof module.

2. The roof module according to claim 1, wherein the kinematic mechanism is configured to move the at least one environment sensor between the at least one retracted position and the at least one deployed position in a rotational movement and/or a translational movement.

3. The roof module according to claim 1, wherein the at least one environment sensor has a sensor housing, the kinematic mechanism having at least two guide levers, which are each connected to the at least one sensor housing in a rotating manner at one end and which are each connected to a support structure of the roof module in a rotating manner at the other end.

4. The roof module according to claim 3, wherein at least a first one of the at least two guide levers has a sliding pin, which is held in a first guide track in a sliding manner.

5. The roof module according to claim 3, wherein the kinematic mechanism has at least one other adjustment lever, which is connected to the second one of the at least two guide levers in a rotating manner at one end and which has a sliding pin at the other end, the sliding pin being held in a second guide track in a sliding manner.

6. The roof module according to claim 3, wherein the at least one environment sensor has a lid element which is coupled to at least one part of the kinematic mechanism and/or to the sensor housing in a movement-transferring manner via at least one coupling element.

7. The roof module according to claim 3, wherein the at least one environment sensor has a cover which is connected to at least one part of the kinematic mechanism and/or to the sensor housing and/or the lid element in a movement-transferring manner via at least one other coupling element.

8. The roof module according to claim 6, wherein the at least one coupling element and/or the at least one other coupling element has at least one linkage and/or at least one Bowden cable and/or at least one pull cable and/or at least one push cable.

9. The roof module according to claim 1, wherein the kinematic mechanism has at least one drive, the drive comprising an electric and/or an electromagnetic and/or an electromechanical and/or a pneumatic and/or a hydraulic drive.

10. The roof module according to claim 1, wherein the roof module has a panel component which at least partially forms a roof skin of vehicle roof, the at least one environment sensor being disposed in an opening of the panel component, and the panel component bordering the at least one panoramic roof element and/or one sunroof and/or one sliding roof.

11. The roof module according to claim 1, wherein the at least one environment sensor comprises a lidar sensor and/or a camera sensor and/or a multi-camera sensor and/or an ultrasonic sensor.

12. A motor vehicle comprising a vehicle body and at least one roof module according to claim 1, the roof module being disposed on the vehicle body as a pre-assembled unit.

13. The motor vehicle according to claim 12, wherein the motor vehicle has at least one windshield and/or one rear window, the kinematic mechanism being configured to move the at least one environment sensor into the at least one deployed position in such a manner that the at least one environment sensor at least partially projects over the outer edge area of the roof module in the direction of the windshield or the rear window.
